(19) United States
(12) Patent Application Publication
(10) Pub. No.: US 2001/0018503 A1
(43) Pub. Date: Aug. 30, 2001

(54) Fluorescent water-soluble polymers

(76) Inventors: Wesley L. Whipple, Naperville, IL (US); Peter E. Reed, Plainfield, IL (US); William J. Ward, Glen Ellyn, IL (US)

Correspondence Address: ONDEO Nalco Company, Patent & Licensing Department, ONDEO Nalco Center, Naperville, IL, 60563-1198, US

(21) Appl. No.: 09/822,745

(22) Filed: Mar. 30, 2001

Related U.S. Application Data
(62) Division of application No. 09/359,467, filed on Jul. 22, 1999.

(51) Int. Cl. C08F 30/04

(52) U.S. Cl. 526/240; 526/287; 526/288; 526/319

(57) ABSTRACT

This invention is directed to water-soluble fluorescent polymers incorporating fluorescent moieties, to a method of monitoring the water-soluble fluorescent polymers in water and to a method of controlling the dosage of a water-soluble polymeric treating agent.

### TECHNICAL FIELD

This invention is directed to water-soluble fluorescent polymers, to a method of monitoring the water-soluble fluorescent polymers in water and to a method of controlling the dosage of a water-soluble polymeric treating agent.

### BACKGROUND OF THE INVENTION

In many fields that employ polymers it is desirable to tag or mark such polymers to facilitate monitoring thereof. “Monitoring” means any type of tracing or tracking to determine the location or route of the polymers, and any type of determination of the concentration or amount of the polymer at any given site, including singular or intermittent or continuous monitoring. For instance, it may be desirable to monitor water treatment polymers in water systems, or to monitor polymers that may be present in waste fluids before disposal, or to monitor the polymer used for down-hole oil well applications, or to monitor polymers that may be present in fluids used to wash a manufactured product.

As seen from the above list of possible applications of polymer monitoring, the purpose of such monitoring may be to trace or track or determine the level of the polymer itself, or to trace or track or determine the level of some substance in association with the polymer, or to determine some property of the polymer or substance in association with the polymer.

Conventional techniques for monitoring polymers are generally time-consuming and labor intensive, and often require the use of bulky and/or costly equipment. Most conventional polymer analysis techniques require the preparation of calibration curves for each type of polymer employed, which is time-consuming and laborious, particularly when a large variety of polymer chemistries are being employed, and the originally prepared calibration curves lose their accuracy if the polymer structures change, for instance an acrylic acid ester mer unit being hydrolyzed to an acrylic acid mer unit.

Polymers tagged with pendant fluorescent groups are capable of being monitored, even when present at low concentrations.

Some polymers tagged with pendant fluorescent groups are known. A process for preparing fluorescent polymers by polymerizing a fluorescent monomer in which an acrylamide moiety and the aromatic fluorescing moiety are directly linked through an amide bond to the aromatic ring of the fluorescing moiety with an ethylenically unsaturated monomer containing an N-methylolamido, etherified N-methylolamido, epoxy, chlorohydrin, ethyleneimino or carboxylic acid chloride group, or a group capable of forming an isocyanate group by heating is disclosed in British Patent No. 1,141,147.

The polymerization of certain vinylic coumarin monomers with N-(2-hydroxypropyl)methacrylamide is disclosed in Collection Czechoslov. Chem Commun, 1980, 45, 727-731.

A method of preparing fluorescent polymers for use as coating compositions comprising polymerization of one or more ethylenically unsubstituted monomers with a fluorescent substituted polynuclear aromatic hydrocarbon monomer is disclosed in U.S. Pat. No. 5,897,811.

Rhodamine esters of hydroxy lower alkyl acrylates, copolymers of the rhodamine esters with diallyldimethyl ammonium chloride and method of treating industrial water with the polymer is disclosed in U.S. Pat. Nos. 5,772,894 and 5,808,103 and U.S. Ser. No. 09/094,546 all of which are assigned to Nalco Chemical Company.

However, there is an ongoing need for additional fluorescent tagged polymers which can be used in a variety of applications.

### SUMMARY OF THE INVENTION

This invention is directed to a fluorescent water-soluble polymer comprising from about 0.0001 to about 10.0 mole percent of one or more fluorescent monomer units of formula

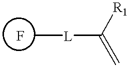

wherein

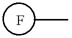

is a fluorescent moiety selected from

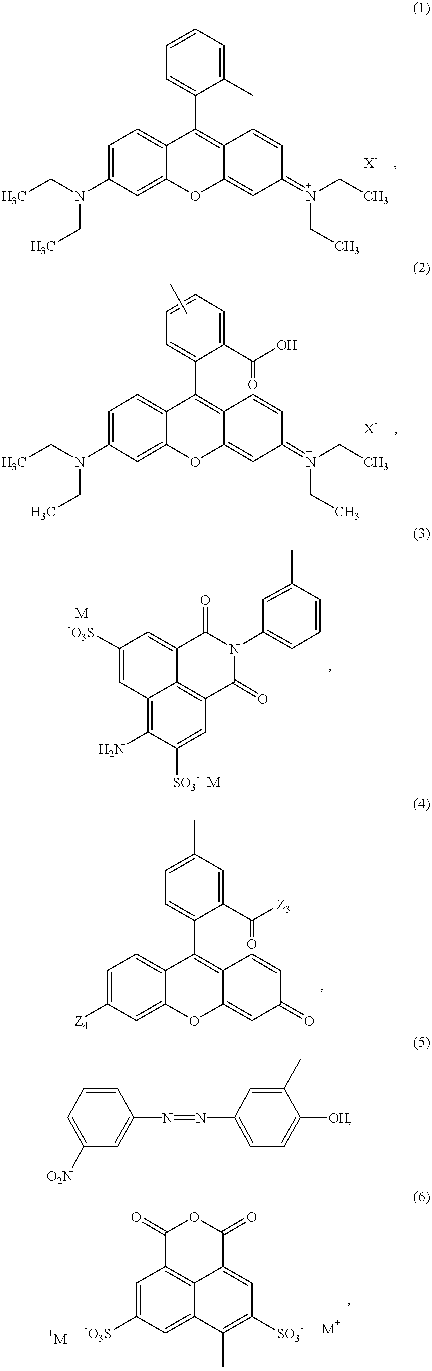

L is selected from —SO₂—, —Y₁C(O)—, —R₂—Y₁—C(O)— and —Y₁—C(Z₁)—Y₂—(CH₂)ₙ—Y₃—C(Z₂)—;

Y₁ is absent, O, or NR₃;

Y₂ and Y₃ are independently O or NR₃;

Z₁ and Z₂ are independently O or S;

Z₃ and Z₄ are independently OH or O⁻M⁺;

n is an integer of from 2 to 6;

R₁ and R₃ are independently hydrogen or C₁-C₄ alkyl;

R₂ is C₁-C₄ alkylene;

X is Br, Cl or I;

M is Na, Li or K,

and from 90 to 99.9999 mole percent of one or more randomly distributed second monomer units selected from the group consisting of cationic, anionic, nonionic and zwitterionic monomers, provided that when the fluorescent water-soluble polymer consists of randomly distributed fluorescent monomer units of formula

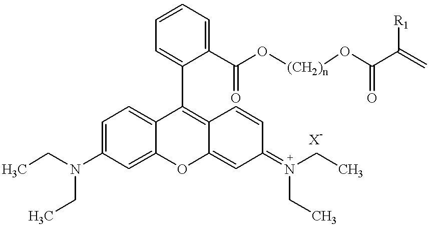

and randomly distributed second monomer units which are diallyldimethyl ammonium chloride, then R₁ is C₁-C₄ alkyl.

### DETAILED DESCRIPTION OF THE INVENTION

Definitions of Terms

Throughout this patent application, the following definitions will be used:

AcAm for acrylamide;

DADMAC for diallyldimethylammonium chloride;

DMAEA for dimethylaminoethyl acrylate;

DMAEA.BCQ for dimethylaminoethyl acrylate benzyl chloride quaternary salt;

DMAEA.MCQ for dimethylaminoethyl acrylate methyl chloride quaternary salt;

DMAPMA for dimethylaminopropylmethacrylamide;

cP for centipoise;

AIVN for 2,2′-azobis(2,4-dimethylvaleronitrile); and

AIBN for 2,2′-azobis(isobutyronitrile).

“Alkyl” means a monovalent group derived from a straight or branched chain saturated hydrocarbon by the removal of a single hydrogen atom. Representative alkyl groups include methyl, ethyl, n- and iso-propyl, n-, sec-, iso- and tert-butyl, and the like. A preferred alkyl group is methyl.

“Alkylene” means a divalent group derived from a straight or branched chain saturated hydrocarbon by the removal of two hydrogen atoms. Representative alkylene groups include methylene, ethylene, propylene, isobutylene, and the like.

“Fluorescent polymer”, Indicator polymer” and “tagged polymer” are used interchangeably and mean polymers which fluoresce as a result of the fluorescent monomer(s) incorporated therein.

“Nonionic polymer” means a polymer which is overall neutral in charge. The nonionic polymer may comprise nonionic monomers, zwitterionic monomers, or a mixture of anionic, cationic zwitterionic and/or nonionic monomers in such amounts as to result in overall neutrality.

“Cationic polymer” means a polymer which possesses a net positive charge. The cationic polymer may comprise cationic monomers, or a mixture of anionic, cationic and/or nonionic monomers in such amounts as to result in the polymer having a net positive charge.

“Anionic polymer” means a polymer which possesses a net negative charge. The anionic polymer may comprise anionic monomers, or a mixture of anionic, cationic and/or nonionic monomers in such amounts as to result in the polymer having a net negative charge.

“Zwitterionic polymer” means a polymer composed from zwitterionic monomers and, possibly, other non-ionic monomer(s). In zwitterionic polymers, all of the polymer chains and segments within those chains are rigorously electrically neutral.

“Monomer unit” means a polymerizable allylic, vinylic or acrylic compound. The monomer unit may be anionic, cationic, zwitterionic or nonionic. Vinyl monomer units are preferred, acrylic monomer units are more preferred.

In those instances where the monomer unit possesses an acidic functional group such as —CO₂H or —SO₃H, the monomer unit is capable of forming base addition salts. “Base addition salt” means the inorganic and organic base addition salts of the monomer unit. These salts are prepared by reacting the acidic monomer with a suitable base such as the hydroxide, carbonate, or bicarbonate of a metal cation, or with ammonia, or an organic primary, secondary, or tertiary amine of sufficient basicity to form a salt with the acidic functional group of the monomer.

Representative alkali or alkaline earth metal salts include sodium, lithium, potassium, calcium, magnesium, and the like. Representative organic amines useful for the formation of base addition salts include, ethylamine, diethylamine, ethylenediamine, ethanolamine, diethanolamine, piperazine, and the like. Preferred base addition salts include the sodium and ammonium salts.

Similarly, in those instances where the monomer unit possesses a basic substituent such as amino, dialkylamino, or alkylamino, the monomer unit is capable of forming acid addition salts. “Acid addition salts” means the inorganic and organic acid addition salts of the monomers. These salts are prepared by reacting the monomer in its free-base form with a suitable inorganic or organic acid and isolating the salt thus formed. Preferred acid addition salts include the hydrochloric acid salt and the sulfuric acid salt.

“Cationic Monomer” means a monomer unit as defined herein which possesses a net positive charge. Representative cationic monomers include the quaternary or acid salts of dialkylaminoalkyl acrylates and methacrylates such as dimethylaminoethylacrylate methyl chloride quaternary salt, dimethylaminoethylacrylate hydrochloric acid salt, dimethylaminoethylacrylate sulfuric acid salt, dimethylaminoethyl acrylate benzyl chloride quaternary salt and dimethylaminoethylacrylate methyl sulfate quaternary salt; the quaternary or acid salts of dialkylaminoalkylacrylamides and methacrylamides such as dimethylaminopropyl acrylamide hydrochloric acid salt, dimethylaminopropyl acrylamide sulfuric acid salt, dimethylaminopropyl methacrylamide hydrochloric acid salt and dimethylaminopropyl methacrylamide sulfuric acid salt, methacrylamidopropyl trimethyl ammonium chloride and acrylamidopropyl trimethyl ammonium chloride; and N,N-diallyldialkyl ammonium halides such as diallyldimethyl ammonium chloride. Preferred cationic monomers include acrylamidopropyl trimethyl ammonium chloride, methacrylamidopropyl trimethyl ammonium chloride, dimethylaminoethylacrylate methyl chloride quaternary salt and dimethylaminoethyl acrylate benzyl chloride quaternary salt.

“Anionic monomer” means a monomer as defined herein which possesses an acidic functional group and the base addition salts thereof. Representative anionic monomers include acrylic acid, methacrylic acid, maleic acid, itaconic acid, 2-propenoic acid, 2-methyl-2-propenoic acid, 2-acrylamido-2-methyl propane sulfonic acid, sulfopropyl acrylic acid and other water-soluble forms of these or other polymerizable carboxylic or sulphonic acids, sulphomethylated acrylamide, allyl sulphonic acid, vinyl sulphonic acid, the quaternary salts of acrylic acid and methacrylic acid such as ammonium acrylate and ammonium methacrylate, and the like. Preferred anionic monomers include 2-acrylamido-2-methyl propanesulfonic acid sodium salt and sodium acrylate.

“Nonionic monomer” means a monomer as defined herein which is electrically neutral. Representative nonionic monomers include N-isopropylacrylamide, N,N-dimethylacrylamide, N,N-diethylacrylamide, dimethylaminopropyl acrylamide, dimethylaminopropyl methacrylamide, acryloyl morpholine, hydroxyethyl acrylate, hydroxypropyl acrylate, hydroxyethyl methacrylate, hydroxypropyl methacrylate, dimethylaminoethyl acrylate, dimethylaminoethyl methacrylate, maleic anhydride, N-vinyl pyrrolidone, vinyl acetate and N-vinyl formamide. Preferred nonionic monomers include acrylamide and methacrylamide. Acrylamide is more preferred.

“Zwitterionic monomer” means a monomer containing cationically and anionically charged functionality in equal proportions, such that the monomer is net neutral overall. Representative zwitterionic monomers include

N,N-dimethyl-N-acryloyloxyethyl-N-(3-sulfopropyl)-ammonium betaine,

N,N-dimethyl-N-methacryloyloxyethyl-N-(3-sulfopropyl)-ammonium betaine,

N,N-dimethyl-N-acrylamidopropyl-N-(2-carboxymethyl)-ammonium betaine,

N,N-dimethyl-N-acrylamidopropyl-N-(2-carboxymethyl)-ammonium betaine,

N,N-dimethyl-N-acryloxyethyl-N-(3-sulfopropyl)-ammonium betaine,

N,N-dimethyl-N-acrylamidopropyl-N-(2-carboxymethyl)-ammonium betaine,

N-3-sulfopropylvinylpyridine ammonium betaine,

2-(methylthio)ethyl methacryloyl-S-(sulfopropyl)-sulfonium betaine,

2-[(2-acryloylethyl)dimethylammonio]ethyl 2-methyl phosphate,

2-(acryloyloxyethyl)-2′-(trimethylammonium)ethyl phosphate,

[(2-acryloylethyl)dimethylammonio]methyl phosphonic acid,

2-methacryloyloxyethyl phosphorylcholine (MPC),

2-[(3-acrylamidopropyl)dimethylammonio]ethyl 2′-isopropyl phosphate (AAPI),

1-vinyl-3-(3-sulfopropyl)imidazolium hydroxide,

(2-acryloxyethyl) carboxymethyl methylsulfonium chloride,

1-(3-sulfopropyl)-2-vinylpyridinium betaine,

N-(4-sulfobutyl)-N-methyldiallylamine ammonium betaine (MDABS),

N,N-diallyl-N-methyl-N-(2-sulfoethyl) ammonium betaine, and the like.

“Cross linker” means an ethylenically unsaturated monomer containing at least two sites of ethylenic unsaturation which is added to branch or increase the molecular weight of the water-soluble fluorescent polymer of this invention. Representative cross-linking agents include methylene bisacrylamide, methylene bismethacrylamide, polyethylene glycol diacrylate, ethylene glycol dimethacrylate, diethylene glycol dimethacrylate, triethylene glycol dimethacrylate, polyethylene glycol dimethacrylate, polypropylene glycol dimethacrylate, N-vinyl acrylamide, divinyl benzene, triallyl ammonium salts, N-methyl allylacrylamide, glycidyl acrylate, acrolein, methylolacrylamide, glyoxal, epichlorohydrin, and the like. The cross linker is added at from about 0.0001 to about 10, preferably from about 0.0001 to about 0.2 weight percent based on the weight of the polymer.

“Solution polymer” means a polymer prepared by a process in which monomers are polymerized in a solvent in which the resulting polymer is soluble. In general, solution polymerization is used to prepare lower molecular weight polymers, as the solution tends to become too viscous as the polymer molecular weight increases.

The preparation of a solution polymer is generally accomplished by preparing an aqueous solution containing one or more water-soluble monomers and any polymerization additives such as chelants, pH buffers or chain transfer agents. This solution is charged to a reactor equipped with a mixer, a thermocouple, a nitrogen purging tube and a water condenser. The solution is mixed vigorously, heated to the desired temperature, and then one or more water-soluble free radical polymerization initiators are added. The solution is purged with nitrogen while maintaining temperature and mixing for several hours. Typically, the viscosity of the solution increases during this period. After the polymerization is complete, the reactor contents are cooled to ambient temperature and transferred to storage.

“Inverse emulsion polymer” and “inverse latex polymer” mean a water-in-oil polymer emulsion comprising a fluorescent polymer according to this invention in the aqueous phase, a hydrocarbon oil for the oil phase and a water-in-oil emulsifying agent. Inverse emulsion polymers are hydrocarbon continuous with the water-soluble polymers dispersed within the hydrocarbon matrix. The inverse emulsion polymers are then “inverted” or activated for use by releasing the polymer from the particles using shear, dilution, and, generally, another surfactant. See U.S. Pat. No. 3,734,873, incorporated herein by reference.

Inverse emulsion polymers are prepared by dissolving the required monomers in the water phase, dissolving the emulsifying agent in the oil phase, emulsifying the water phase in the oil phase to prepare a water-in-oil emulsion, homogenizing the water-in-oil emulsion and polymerizing the monomers to obtain the polymer. A self-inverting surfactant may be added to the water-soluble polymer dispersed within the hydrocarbon matrix to obtain a self-inverting water-in-oil emulsion. Alternatively, a polymer solution can be made-up by inverting the polymer dispersed in oil in to water containing the surfactant.

“Dispersion polymer” means a dispersion of fine particles of polymer in an aqueous salt solution which is prepared by polymerizing monomers with stirring in an aqueous salt solution in which the resulting polymer is insoluble. The dispersion polymer may be prepared using batch or semi-batch polymerization methods.

In a batch polymerization, the polymeric stabilizers, chain transfer agents, monomers, chelant, and water are initially added to the reactor. All or a portion of the formulation salt/salts are also added to the reactor at this time. Mechanical agitation is started and the reactor contents are heated to the desired polymerization temperature. When the set-point temperature is reached, the initiator is added and a nitrogen purge is started. The reaction is allowed to proceed at the desired temperature until completion and then the contents of the reactor are cooled. Additional inorganic salts may be added during or after the polymerization to maintain processability or influence final product quality. Moreover, additional initiator may be added during the reaction to achieve desired conversion rates and facilitate reaction completeness.

A semi-batch polymerization method will vary from a batch polymerization method only in that one or more of the monomers used in the synthesis of the polymer are held out in part or whole at the beginning of the reaction. The withheld monomer is then added over the course of the polymerization. If acrylamide monomer inhibited by copper is used as a semi-batch monomer, a chelant is often also added during the semi-batch period.

In addition to the water-soluble polymer, the dispersion polymer includes other reaction components of water, inorganic salts, polymeric stabilizers, initiators, and RSV stabilizers. The purpose of the water is to act as a polymerization media. Inorganic salts and polymeric stabilizers serve to promote precipitation and act as processing aids. The polymeric stabilizer also serves as a particle stabilizing agent. The initiators are used to initiate the polymerization reaction. The RSV stabilizers are used to stabilize the molecular weight of the polymer.

Representative preparations of dispersion polymers are described in U.S. Pat. Nos. 4,929,655, 5,006,590, 5,597,858 and 5,597,859, European Patent Nos. 657,478 and 630,900 and published International Patent Application no. WO 97/34933, incorporated herein by reference.

“Dry polymer” means a high molecular weight polymer which is prepared by solution polymerization techniques as described herein. As the solution becomes too viscous after polymerization is initiated, the reaction is carried out without agitation. The polymerization product has an extremely high viscosity and the appearance of a solid. Dry polymers may also be referred to as gel polymers.

The preparation of high molecular weight water-soluble polymers as dry powders is generally accomplished by placing an aqueous solution of water-soluble monomers, generally 20-60 percent concentration by weight, along with any polymerization or process additives such as chain transfer agents, chelants, pH buffers, or surfactants in an insulated reaction vessel equipped with a nitrogen purging tube. A polymerization initiator is added, the solution is purged with nitrogen, and the temperature of the reaction is allowed to rise uncontrolled. When the polymerized mass is cooled, the resultant gel is removed from the reactor, shredded, dried, and ground to the desired particle size.

Within a series of polymer homologs which are substantially linear and well solvated, “reduced specific viscosity (RSV)” measurements for dilute polymer solutions are an indication of polymer chain length and average molecular weight. The RSV is measured at a given polymer concentration and temperature and calculated as follows:

$$RSV = \frac{[ ( η / {η}_{0} ) - 1 ]}{c}$$

η=viscosity of polymer solution

ηₒ=viscosity of solvent at the same temperature

c=concentration of polymer in solution.

The units of concentration “c” are (grams/100 ml or g/deciliter). Therefore, the units of RSV are dl/g. In this patent application, for measuring RSV, the solvent used is 1.0 molar sodium nitrate solution. The polymer concentration in this solvent is 0.045 g/dl. The RSV is measured at 30° C. unless otherwise indicated. The viscosities η and ηₒ are measured using a Cannon Ubbelohde semimicro dilution viscometer, size 75. The viscometer is mounted in a perfectly vertical position in a constant temperature bath adjusted to 30±0.02° C. The error inherent in the calculation of RSV is about 2 dl/grams. When two polymer homologs within a series have similar RSV's that is an indication that they have similar molecular weights.

IV stands for intrinsic viscosity, which is RSV in the limit of infinite polymer dilution (i.e. the intercept where polymer concentration is extrapolated to zero). The IV, as used herein, is obtained from the y-intercept of the plot of RSV versus polymer concentration in the range of 0.015-0.045 wt % polymer.

Preferred Embodiments

The water-soluble polymers of this invention are prepared by polymerizing one or more fluorescent monomers of formula (1)-(11) with one or more second monomers selected from cationic, nonionic, anionic and zwitterionic monomers as defined herein. The second monomers are synthesized using techniques known to persons of ordinary skill in the art of polymer synthesis or they can be purchased from Aldrich Chemical Company, Milwaukee, Wis., USA, Kohjin Co. Ltd., Tokyo, Japan, E.I. DuPont de Nemours & Co., Wilmington, Del., USA, Rohm & Haas Company, Philadelphia, Pa., USA, BASF Corp., Parsippany, N.J., USA, Rohm Tech Inc., Malden, Mass., USA, Nalco Chemical Co., Naperville, Ill., USA and NCF Manufacturing, Inc., Riceboro, Ga., USA.

The water-soluble polymers may be solution polymers, dry polymers, inverse emulsion polymers or dispersion polymers.

The water-soluble polymers may be nonionic, cationic, anionic or zwitterionic.

The polymerization reactions described herein are initiated by any means which results in generation of a suitable free-radical. Thermally derived radicals, in which the radical species results from thermal, homolytic dissociation of an azo, peroxide, hydroperoxide and perester compound are preferred. Especially preferred initiators are azo compounds including 2,2′-azobis(2-amidinopropane) dihydrochloride, 2,2′-azobis[2-(2-imidazolin-2-yl)propane] dihydrochloride, 2,2′-azobis(isobutyronitrile) (AIBN), 2,2′-azobis(2,4-dimethylvaleronitrile) (AIVN), and the like.

Preferred water-soluble polymers comprise from about 0.0001 to about 10 mole percent fluorescent monomer units and from about 90 to about 99.9999 mole percent second monomer units.

More preferred water-soluble polymers comprise from about 0.02 to about 0.5 mole percent fluorescent monomer units and from about 99.5 to about 99.98 mole percent second monomer units.

The fluorescent water-soluble polymers have an RSV from 0.1 to 80 dl/g.

Preferred fluorescent water-soluble polymers used for water-treatment applications such as flocculation, have an RSV from 5 to 50 dl/g. More preferred fluorescent water-soluble polymers used for water-treatment applications such as flocculation have an RSV from 10 to 50 dl/g.

Preferred cross-linked fluorescent water-soluble polymers used for water-treatment applications such as flocculation have an RSV from 1 to 30 dl/g. More preferred cross-linked water-soluble polymers used for water-treatment applications such as flocculation have an RSV from 2 to 15 dl/g. Still more preferred cross-linked fluorescent water-soluble polymers used for water-treatment applications such as flocculation have an RSV from 3 to 8 dl/g.

Preferred fluorescent water-soluble polymers used for water-treatment applications such as coagulation have an RSV from 0.1 to 5 dl/g. More preferred fluorescent water-soluble polymers used for water-treatment applications such as coagulation have an RSV from 0.5 to 5 dl/g.

Preferred water-soluble fluorescent polymers used as dispersants have a molecular weight from 1,000 to 1,000,000. More preferred fluorescent water-soluble polymers used as dispersants have a molecular weight from 1,000 to 100,000.

The preparation of the fluorescent monomers used for preparing the water-soluble fluorescent polymers of this invention is outlined in Schemes 1-4. It is understood that the fluorescent moeity may be substituted with functional groups possessing reactivity such that they could potentially interfere with the reactions described below. In such instances, the functional groups should be suitably protected. For a comprehensive treatise on the protection and deprotection of common functional groups see T. H. Greene and P. G. M. Wuts, Protective Groups in Organic Synthesis, 2^{nd} edition, John Wiley & Sons, New York, 1991, incorporated herein by reference.

The preparation of flourescent monomers wherein L is —Y₁—C(Z₁)—Y₂—(CH₂)ₙ—Y₃—C(Z₂)— wherein Y₁ is absent and Z₁, Z₂, n, Y₂ and Y₃ are defined herein is shown in Scheme 1.

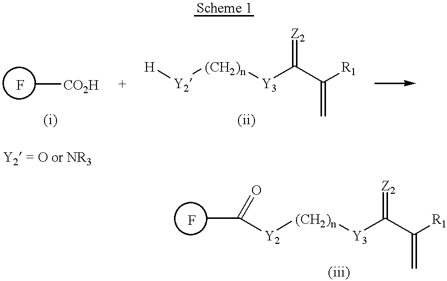

As shown in the foregoing Scheme 1, coupling of the fluorescent carboxylic acid compound (i) with the alcohol (Y₂′=O) or amine (Y₂′=NR3) (ii) results in formation of the fluorescent monomer (iii). The coupling is accomplished using techniques well known in the art for forming esters and amides.

In particular, the coupling is generally accomplished in the presence of one or more carboxylic acid activating agents. Representative activating agents include isopropyl chloroformate, carbonyldiimidazole, diisopropylcarbodiimide (DIC), 1-(3-dimethylaminopropyl)-3-ethylcarbodiimide (EDC), 1-hydroxybenzotriazole (HOBT), bis(2-oxo-3-oxazolidinyl)phosphonic chloride (BOP-Cl), benzotriazole-1-yloxy-tris-((dimethylamino)phosphonium)hexafluorophosphate (BOP), benzotriazole-1-yloxy-tris-pyrrolidino-phosphonium hexafluorophosphate (PyBROP), bromo-tris-pyrrolidino-phosphonium hexafluorophosphate (PyBOP), 2-(1H-benzotriazol-1-yl)-1.1.3.3-tetramethyluronium tetrafluoroborate (TBTU), 2-(1H-benzotriazol-1-yl)-1.1.3.3-tetramethyluronium hexafluoroborate (HBTU), 2-[2-oxo-1-(2H)-pyridyl]-1,1,3,3-bis-pentamethyleneuronium tetrafluoroborate (TOPPipU), N,N′-dicyclohexylcarbodiimide (DCC), 4-dimethylaminopyridine (DMAP) and the like. Suitable solvents for the coupling reaction include dichloromethane, DMF, DMSO, THF, and the like. Coupling times range from about 2 to about 24 hours depending on the fluorescent carboxylic acid compound, activating agent, solvent and temperature. Catalysts such as 4-dimethylaminopyridine (DMAP) or 1-hydroxybenzotriazole may be used to increase the rate of reaction or reduce byproduct formation. Bases such as pyridine or triethylamine may be used to scavenge acids which may be liberated during the coupling reaction. The coupling is accomplished at from about −10° C. to about 50° C., preferably at about ambient temperature.

The coupling of the fluorescent carboxylic acid compound (I) with the alcohol or amine (ii) may also be accomplished by converting the fluorescent carboxylic acid compound to a more reactive derivative which will react directly with the alcohol or amine. For example, reaction of the fluorescent carboxylic acid compound with reagents like thionyl chloride, phosphorous pentachloride or cyanuric chloride results in formation of the acid chloride which is then reacted with the alcohol or amine in the presence of base to form the desired fluorescent monomer (iii).

When Y₂′ is NR₃, the free amine or the acid addition salt of the amine may be employed in the coupling reaction. When the acid addition salt is utilized, the free amine may be generated in advance or in situ by the addition of a suitable base such as triethylamine.

The coupling is preferably accomplished in dichloromethane at about ambient temperature in the presence of dicyclohexylcarbodiimide and 4-dimethylaminopyridine.

The fluorescent monomer wherein Z₁ is S is prepared from (iii) using methods known in the art for exchanging sulfur and oxygen.

The preparation of fluorescent monomers wherein L is —Y₁—C(Z₁)—Y₂—(CH₂)ₙ—Y₃—C(Z₂)— or —Y₁C(O)— wherein Y₁ is O or NR₃ and Z₁, Z₂, n, Y₂ and Y₃ are defined herein is shown in Scheme 2.

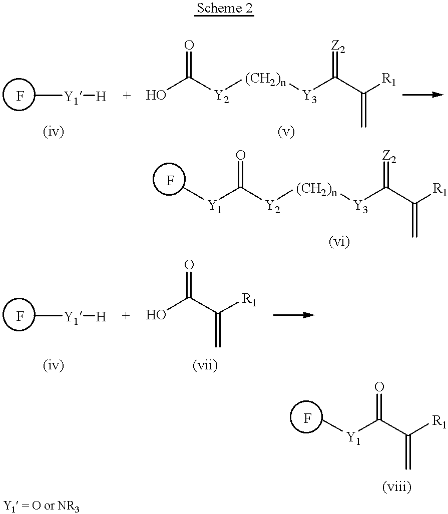

As shown in the foregoing Scheme 2, coupling of the fluorescent alcohol (Y₁′=O) or amine (Y₁′=NR₃) compounds (v) or (vii) using the methods described in Scheme 1 above for the preparation of esters and amides results in formation of the fluorescent monomers (vi) or (viii).

The preparation of fluorescent monomers in which L is wherein L is —SO₂— is shown in Scheme 3.

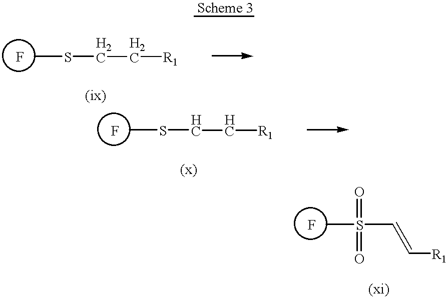

As shown in Scheme 3, fluorescent monomers in which L is SO₂ may be prepared using methods known in the art for the preparation of vinyl sulfones. For example, chlorination of mercaptan (ix) using SOC12, followed by dehydrochlorination by heating in the presence of a base such as pyridine results in formation of the vinyl sulfide (x) which is then oxidized to the sulfone (xi) using, for example H₂O₂/acetic acid. See Fieser & Fieser, Reagents for Organic Synthesis, vol. 10, page 315 (John Wiley & Sons, 1982).

The preparation of fluorescent monomers wherein L is —R₂Y₁C(O)— wherein R₂ is defined herein and Y₁ is O or NR₃ is shown in Scheme 4.

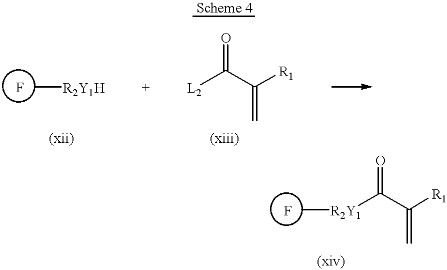

As shown in Scheme 4, reaction of alcohol (xii) (Y₁=O) or amine (xii) (Y₁=NR₃) with the activated acrylic compound (xiii) (L₂=halogen, OR′ where R′ is alkyl or aryl, OC(O)R′) results in formation of the fluorescent monomer (xiv). The reaction may be conducted in the presence of base or additional carbonyl activating compounds as is known in the art. c.f. Jerry March, Advanced Organic Chemistry, Reactions, Mechanisms and Structure, 382-383, 386 (2^{nd} edition, McGraw-Hill Book Company, 1977).

Preferred fluorescent monomers are selected from

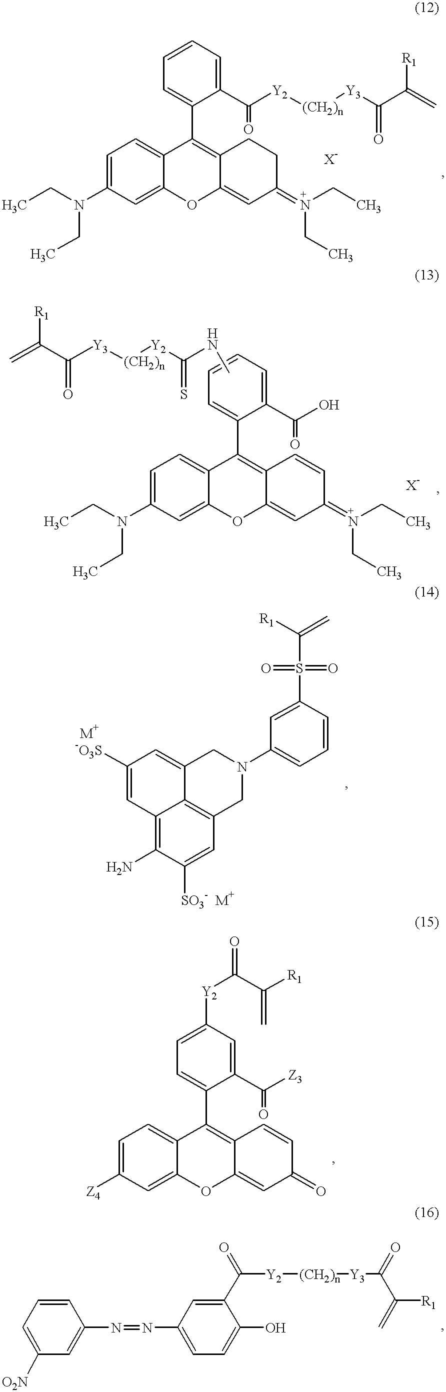

Preferred second monomers are selected from acrylamide, acrylic acid, sodium acrylate, ammonium acrylate, methacrylamide, vinyl acetate, dimethylaminoethylacrylate methyl chloride quaternary salt, dimethylaminoethylacrylate benzyl chloride quaternary salt, diallyldimethyl ammonium chloride, N-vinyl formamide, dimethylaminoethylmethacrylate acid salts, including, but not limited to, sulfuric acid salts and hydrochloric acid salts, dimethylaminoethylmethacrylate methyl chloride quaternary salt, dimethylaminoethyl methacrylate benzyl chloride quaternary salt, methacrylamidopropyltrimethylammonium chloride and acrylamidopropyltrimethylammonium chloride.

More preferred second monomers are selected from acrylamide, dimethylaminoethylacrylate methyl chloride quaternary salt, dimethylaminoethylmethacrylate methyl chloride quaternary salt, sodium acrylate, ammonium acrylate, acrylamidopropyltrimethylammonium chloride and methacrylamidopropyltrimethylammonium chloride.

Still more preferred second monomers are selected from acrylamide, dimethylaminoethylacrylate methyl chloride quaternary salt, sodium acrylate and ammonium acrylate.

More preferred fluorescent monomers are selected from:

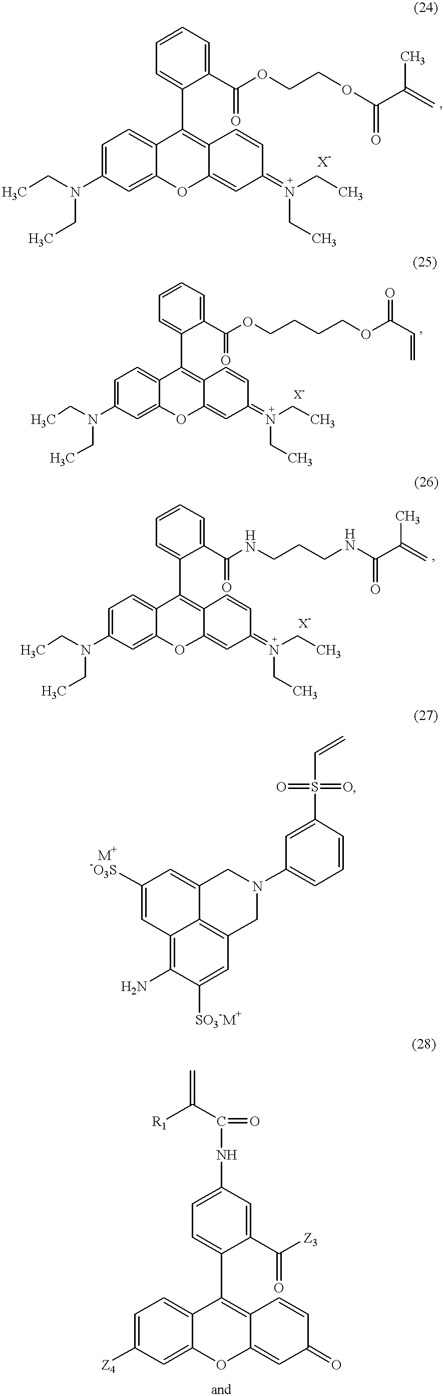

In another aspect, this invention is directed to a fluorescent water-soluble polymer as described herein further comprising a cross-linker.

In another aspect, this invention is directed to a fluorescent monomer of formula

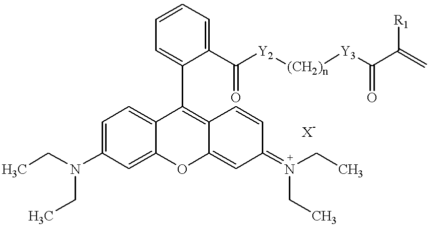

wherein

Y₂ and Y₃ are independently O or NR₃;

R₁ is C₁-C₄ alkyl;

R₃ is H or C₁-C₄ alkyl;

n is an integer of from 2 to 6; and

X is Br, Cl or I.

In a preferred aspect of the foregoing, R₁ is methyl and R₃ is H.

In another preferred aspect of the foregoing, R₁ is methyl, Y₂ and Y₃ are O and n is 2.

In another preferred aspect of the foregoing, R₁ is methyl, Y₂ and Y₃ are NH and n is 2.

In another aspect, this invention is directed to a method of monitoring a fluorescent water-soluble polymer in treated water comprising adding to the water-soluble fluorescent water-soluble polymer of claim 1 and monitoring the water-soluble fluorescent polymer by fluorescence detection.

The water-soluble fluorescent polymer may be the treating agent, or can be added in combination with another polymeric treating agent.

Accordingly, in another aspect, this invention is directed to a composition comprising a water-soluble fluorescent polymer as described herein and a polymeric treating agent.

For example a poly(acrylic acid) polymer tagged as described herein can be used as the treating agent and as the indicator polymer. Alternatively, poly(acrylic acid) would be used as the polymeric treating agent and the corresponding tagged poly(acrylic acid) would be the indicator polymer. However, if the two are different, a minimally detectable amount of the water-soluble indicator polymer would be utilized in conjunction with the untagged water-soluble polymeric treating agent.

As used herein, the term water-soluble polymeric treating agent refers to polymers which are added to aqueous systems for the purpose of scale control, corrosion inhibition, dispersing, flocculating, coagulating and thickening among others. The treated water may be either natural or industrial water. The industrial waters may be municipal wastewater, chemical processing wastewater, boiler water, cooler water and water utilized in papermaking and mining applications among others.

“Predetermined amount”, in reference to the water-soluble polymeric treating agent, refers to an amount required by the system to effect a particular treatment. For example, if the water is a boiler water, the predetermined amount would be the effective corrosion-preventing amount of polymer required by that particular aqueous system to prevent corrosion. As used herein, the term predetermined effective indicating amount refers to a minimal amount which can be detected by a fluorescence technique (above the native fluorescence of the aqueous system being treated). The water-soluble polymeric treating agent and the water-soluble polymeric indicator may be blended prior to addition, or added individually in sequential fashion. Once they have been added to the system, a portion of that treated water can be removed for analysis. “Analyzing the emissivity” refers to monitoring by a fluorescence technique. Such techniques, and required calculations to correlate fluorescence to concentration are described in U.S. Pat. Nos. 5,435,969; 5,171,450 and 4,783,314 among others. U.S. Pat. Nos. 5,435,969; 5,171,450 and 4,783,314 are incorporated herein by reference.

The water-soluble fluorescent polymers of this invention are particularly useful for elucidating the mechanism of action of a polymeric treating agent. This allows better control of polymer dosage, thereby maximizing the efficiency of the polymer treatment and concomitant minimization of the contribution of the polymers to pollution.

Accordingly, in another aspect, this invention is directed to a method of controlling the dosage of a water-soluble polymeric treating agent added to water comprising:

a) adding a predetermined amount of the water-soluble fluorescent polymer of claim 1 to the water,

b) monitoring the change in fluorescence of the water-soluble fluorescent polymer and

d) adjusting the concentration of said polymeric treating agent accordingly.

“Adjusting the concentration of said polymeric treating agent accordingly” means that the amount of the water-soluble polymeric treating agent is adjusted based on some significant change in the fluorescence measurement. The actual fluorescence measurement may either increase or decrease depending on the application, as a function of polymer dosage, or the relative changes in the fluorescence measurement may either become larger or smaller as a function of polymer dosage.

When such changes occur at or near the optimum polymer dosage as represented by some other parameter of interest (for example drainage, turbidity reduction, color removal, etc.) then the trends in the fluorescence measurement can be used to determine and maintain the proper dosage of the polymeric treating agent for the particular parameter of interest. The method is particularly suited to applications where such instantaneous feedback could be provided by an in-line fluorescence monitoring device would be used as part of a system to control a polymer feeding pump, for example, wherein the polymer dosage is increased or decreased depending on the response from the fluorescence measurement device.

For instance, it may be desirable to monitor water treatment polymers in water systems, particularly industrial water systems, or to monitor polymers that may be present in waste fluids before disposal, particularly industrial waste fluids, or to monitor the polymer used for down-hole oil well applications, particularly the route taken after introduction down-hole, or to monitor polymers that may be present in fluids used to wash a manufactured product, for instance a polymer-coated product, to determine the amount of polymer washed or leached therefrom. By fluids or liquids as used herein generally is meant aqueous, non-aqueous, and mixed aqueous/non-aqueous fluid systems.

The foregoing may be better understood by reference to the following Examples which are presented for purposes of illustration and are not intended to limit the scope of the invention.

### EXAMPLE 1

2-(2-hydroxyethyl)methacrylate/rhodamine B ester, (24) is synthesized as follows:

Rhodamine B (2.27 g, 4.7 mmol, 99+% available from ACROS Organics, New Jersey) and 17 ml of anhydrous methylene chloride is added to a 25 ml baffled flask stirred with a magnetic bar. A red solution results. To the solution, is added dimethylaminopyridine (0.06 g, 0.5 mmol, available from Aldrich Chemical Co., Milwaukee, Wis.), and 1,3-dicyclohexylcarbodiimide (1.02 g, 5.0 mmol, 99% available from Aldrich Chemical Co., Milwaukee, Wis.). A rubber septum is placed on the flask, and the reaction mixture is stirred for 5 minutes. Hydroxyethyl methacrylate (0.584 ml, 0.604 g, 5.2 mmol) is added by syringe and the reaction mixture is stirred at 22° C. for 3.5 hours. At the end of the reaction period, a white solid (1,3-dicyclohexyl urea, m.p. 230-231° C., 0.79 g, 3.5 mmol) is removed by filtration. From the filtrate, methylene chloride is removed by rotary evaporation, to give 3.37 g of crude 2-hydroxyethylmethacrylate/rhodamine B ester, (24), as a red solid which is purified by preparative TLC (methanol/ethyl acetate 6:4, Whatman 20×20 cm, 60 Å silica gel, 1 mm thick on glass) to give title compound as a red solid which is used without further purification.

### EXAMPLE 2

Fluorescent 10% cationic (90/10 acrylamide/DMAEA.MCQ) water-in-oil emulsion polymer (Polymer A) is synthesized as follows.

An aqueous monomer phase solution is prepared by stirring together 0.0467 g of the 2-hydroxyethylmethacrylate/rhodamine B ester, (24), prepared according to example 1, 18.2 g of a 49.6% aqueous solution of acrylamide, 0.45 g of adipic acid, 1.35 g of NaCl, 3.41 g of a 80.3% aqueous solution of DMAEA.MCQ, 8.9 g of water, and 0.009 g of EDTA.4Na⁺ until the components are dissolved.

An oil phase is prepared by heating a mixture of 11.7 g of paraffinic oil, 0.23 g of POE (4) sorbitan monostearate, and 0.68 g of sorbitan monooleate until the surfactants dissolved (54-57° C.).

The oil-phase is charged into a 125 mL reaction flask, and heated to 45° C. The monomer phase is added dropwise with vigorous stirring over 2 minutes. The resulting mixture is stirred for 90 minutes to form a water-in-oil emulsion.

To the water-in-oil emulsion is added 0.0100 g of AIBN (2,2′-azobis(isobutyronitrile), available from E.I. duPont Nemours & Co. Inc.; Wilmington, Del.) and 0.0014 g of AIVN (2,2′-azobis(2,4-dimethylvaleronitrile), available from E.I. duPont Nemours & Co. Inc.; Wilmington, Del.). The polymerization is carried out under a N₂ atmosphere for 4 hours at 45° C., then 70° C. for one hour. An RSV of 21 dl/g (1M NaNO₃, 450 ppm, 30° C.), and an 87% tag incorporation is measured for the resulting polymer. The unbound tag is successfully removed by precipitating the emulsion polymer in a 1:1 MeOH/acetone mixture. An RSV of 17 dl/g (1M NaNO₃, 450 ppm, 30° C.) is measured for the resulting dry polymer.

Incorporation of the fluorescent tag into the high molecular weight fractions of the polymer products is verified chromatographically, using a 20 cm×7.8 mm ID column packed in-house with Waters Accell Plus QMA packing. A mobile phase containing 1% acetic acid, 0.10 M sodium sulfate and 0.01 M tetrabutylammonium hydrogen sulfate is used to separate tagged high molecular weight polymer from low molecular weight polymer and residual fluorescent monomer, if present. A waters 410 refractive index detector and a Shimadzu RF-530 fluorescence detector are used simultaneously to quantitate incorporation and determine fluorescence relative to untagged controls.

### EXAMPLE 3

Fluorescent 30% cationic (70/30 acrylamide/DMAEA.MCQ) water-in-oil emulsion polymer (Polymer B) is prepared as follows.

An aqueous monomer phase solution is prepared by stirring 0.01 g of 2-(4-hydroxybutyl)acrylate/rhodamine B ester (25), prepared as described in U.S. Pat. No. 5,772,894, 13.1 g of a 47.5% aqueous solution of acrylamide, 0.45 g of adipic acid, 1.35 g of NaCl, 9.2 g of a 79.3% aqueous solution of DMAEA.MCQ, 7.8 g of water, and 0.18 g of a 5% aqueous solution of EDTA.4Na⁺ until the components are dissolved.

An oil phase is prepared by heating a mixture of 11.7 g of paraffinic oil, 0.94 g of POE (4) sorbitan monostearate, and 0.41 g of sorbitan monooleate until the surfactants dissolved (54-57° C.).

The oil-phase is charged into a 125 mL reaction flask, and heated to 45° C. The monomer phase is added dropwise with vigorous stirring over 2 minutes and the resulting mixture is stirred for 90 minutes.

To the resulting water-in-oil emulsion is added 0.014 g of AIBN (2,2′-azobis(isobutyronitrile), available from E.I. duPont Nemours & Co. Inc.; Wilmington, Del.) and 0.001 g of AIVN (2,2′-azobis(2,4-dimethylvaleronitrile), available from E.I. duPont Nemours & Co. Inc.; Wilmington, Del.). The polymerization is carried out under a N₂ atmosphere for 3.75 hours at 45° C., then 55° C. for one hour. An RSV of 15 dl/g (1M NaNO₃, 450 ppm, 30° C.), and a 60-80% tag incorporation is measured for the resulting polymer. A dry polymer with an RSV of 9 dl/g (1 M NaNO₃, 450 ppm, 30° C.) is formed by precipitating the emulsion polymer in a 1:1 MeOH/acetone mixture. Polymers C-D of Table I are similarly synthesized.

TABLE I
Representative Fluorescent Cationic Emulsion Polymers

| | | | | Polymer |
|---|---|---|---|---|
| | Mole % | Tag | | RSV |
| Polymer | DMAEA*MCQ | ID | Mole % | (dl/g) |
| A | 10 | 24 | 0.06 | 21.1 |
| B | 30 | 25 | 0.01 | 15.1 |
| C | 30 | 27 | 0.15 | 16.6 |
| D | 30 | 29 | 0.18 | 6.0 |

### EXAMPLE 4

N-(3-aminopropyl)methacrylamide/rhodamine B amide, (26) is synthesized as follows.

To a 10 mL flask with magnetic stirring is added N-(3-aminopropyl)methacrylamide.HCl (0.37 g, 2.1 mmol, available from Polysciences, Inc., Warrington, Pa.) and 2 ml of anhydrous methylene chloride. Triethylamine (0.23 g, 2.1 mmol) is added to the slurry, and the resulting mixture is stirred for 2 hours.

Separately, rhodamine B (1.0 g, 2.1 mmol, 80+% available from Aldrich Chemical Co., Milwaukee, Wis.) and 10 ml of anhydrous methylene chloride is added to a 25 mL baffled flask stirred with a magnetic bar. A red solution results. To the solution is added dimethylaminopyridine (0.026 g, 0.22 mmol, available from Aldrich Chemical Co., Milwaukee, Wis.), and 1,3-dicyclohexylcarbodiimide (0.43 g, 2.1 mmol, 99% available from Aldrich Chemical Co., Milwaukee Wis.). A rubber septum is placed on the flask, and the reaction mixture is stirred for 5 minutes. The contents of the first flask are transferred to the flask containing the rhodamine B mixture, including 2 ml of methylene chloride washings. The resulting mixture is stirred overnight.

The resulting white solid (0.46 g) is removed from the reaction mixture by filtration, and the solvent is removed from the filtrate to yield 1.62 g of crude N-(3-aminopropyl)methacrylamide/rhodamine B amide, (26). The crude material is used without further purification.

### EXAMPLE 5

Fluorescent 10% cationic (90/10 acrylamide/DMAEA.MCQ) water-in-oil emulsion polymer (Polymer E) is synthesized according to the method of Example 2, except 0.0649 g of crude N-(3-aminopropyl)methacrylamide/rhodamine B amide, (26), is used in the formulation instead of the 2-hydroxyethylmethacrylate/rhodamine B ester, (24). A fluorescent water-in-oil latex emulsion polymer with an RSV of 8.4 dl/g (1M NaNO₃, 450 ppm, 30° C.) is obtained.

### EXAMPLE 6

Fluorescent 29% anionic (71/29 acrylamide/sodium acrylate) water-in-oil emulsion polymer with the Lucifer Yellow-VS tag ((27), Polymer F) is synthesized as follows.

An aqueous monomer solution is made-up by stirring 17.2 g of a 49.6% aqueous solution of acrylamide, 7.84 g of water, and 3.54 g of acrylic acid. To the above solution in an ice bath is added 3.98 g of a 50% aqueous solution of sodium hydroxide to obtain Ph 7.5. Lucifer Yellow-VS ((27), 0.12 g, available from Aldrich Chemical Co., Milwaukee, Wis.) is added to the monomer solution, and the reaction mixture is stirred for 80 minutes. To the resulting yellow solution, 0.08 g of a 5% aqueous EDTA.4Na⁺ solution is added.

An oil phase is prepared by heating a mixture of 11.4 g of paraffinic oil, 0.33 g of POE (4) sorbitan monostearate, and 0.55 g of sorbitan monooleate until the surfactants dissolve (54-57° C.).

The oil-phase is charged into a 125 mL reaction flask, and heated to 45° C. The monomer phase is added dropwise with vigorous stirring over 2 minutes. The resulting mixture is stirred for 90 minutes.

To the resulting water-in-oil emulsion is added 0.025 g of AIBN (2,2′-azobis(isobutyronitrile), available from E.I. duPont Nemours & Co. Inc.; Wilmington, Del.). The polymerization is carried out under a N₂ atmosphere for 4 hours at 45° C., then 1 hour at 70° C. An RSV of 23 dl/g (1M NaNO₃, 450 ppm, 30° C.), and a tag incorporation of 59% is measured for the resulting polymer (dual detector LC technique of Example 2). Precipitation of the emulsion polymer in a 1:1 MeOH/acetone mixture yields a dry polymer with 74% tag incorporation, and an RSV of 26 dl/g (1M NaNO₃, 450 ppm, 30° C.).

### EXAMPLE 7

Fluorescent 29% anionic (71/29 acrylamide/sodium acrylate) water-in-oil emulsion polymer with the fluorescenyl acrylamide tag (Polymer G) is synthesized according to the method of Example 6, except 0.035 g of fluorescenyl acrylamide ((28), synthesized according to C. Munkhohn, et al., J. Am. Chem. Soc., 1990, 112, 2608-12), is used instead of Lucifer Yellow-VS. A fluorescent water-in-oil emulsion polymer with an RSV of 5 dl/g (1M NaNO₃, 450 ppm, 30° C.), and 47% tag incorporation (dual detector LC technique of Example 2) is obtained.

### EXAMPLE 8

35 Mole % cationic (65/25/10 acrylamide/DMAEA.BCQ/DMAEA.MCQ) fluorescent dispersion polymer is synthesized by combining 406 g of deionized water, 145 g of a 49.2% aqueous solution of acrylamide, 130 g of an 80% aqueous solution of DMAEA.BCQ (dimethylaminoethyl acrylate, benzyl chloride quaternary salt), 37.2 g of an 80% aqueous solution of DMAEA.MCQ (dimethylaminoethyl acrylate methyl chloride quaternary salt), 15.4 g of glycerin, 50.6 g of a DADMAC (diallyldimethyl ammonium chloride)/DMAEA.BCQ copolymer (20% aqueous solution), 0.30 g of ethylene diamine tetraacetic acid, tetra sodium salt, and 157 g of ammonium sulfate in a 1.5-L baffled polymer reactor.

This mixture is heated to 48° C. with vigorous mixing and 1.2 g of a 1% aqueous solution of V-50 (2,2′-azobis-(2-amidinopropane) dihydrochloride, available from Wako Chemicals, USA, Inc.; Richmond, Va.) is added, and a nitrogen purge is introduced. After two hours, an additional 2.6 g of a 1% solution of V-50, and a solution of 0.04 g fluorescent monomer (25) in 0.5 ml water is added. After four hours, an additional 0.2 g of V-50 in 1 ml of water is added to the mixture, and the temperature is increased to 65° C. for two hours. The mixture is polymerized for six hours (total) under these conditions, cooled to room temperature and then 43 g of ammonium sulfate, 1 g of ammonium thiocyanate, and 10 g of acetic acid is added to reduce the viscosity of the polymer-in-salt dispersion, and to adjust the pH. The product is a fluorescent-red liquid. A Reduced Specific Viscosity (RSV) of 14.1 dl/g (0.125 N sodium nitrate, 30° C.) is measured for a 450 ppm solution of the product.

The incorporation of the tag into the polymer backbone is confirmed by GPC coupled with fluorescence detection (Waters Accell Plus QMA packing). The fluorescence intensity of the tagged polymer is 600 times greater than for an unlabeled control (EX/EM 552/581 nm).

### EXAMPLE 9

A fluorescent 50% cationic branched (50/50 acrylamide/DMAEA.MCQ) water-in-oil emulsion polymer (Polymer I) is synthesized in the following manner.

An aqueous monomer phase solution is made-up by stirring together 0.05 g of the 2-(2-hydroxyethyl)methacrylate/rhodamine B ester, ((24), Example 1), 10.3 g of a 50.1% aqueous solution of acrylamide, 0.45 g of adipic acid, 1.35 g of NaCl, 17.6 g of a 80.2% aqueous solution of DMAEA.MCQ, 0.12 g of water, 0.96 g of a 0.02% solution of N,N′-methylenebisacrylamide in water, and 0.18 g of a 5% aqueous solution of EDTA.4Na⁺. The components are stirred until in solution.

An oil phase is prepared by heating a mixture of 12.6 g of paraffinic oil, 0.95 g of POE (4) sorbitan monostearate, and 0.45 g of sorbitan monooleate until the surfactants dissolved (54-57° C.).

The oil-phase is charged into a 125 mL reaction flask, and heated to 45° C. With vigorous stirring, the monomer phase is added dropwise over 2 minutes. The resulting mixture is stirred for 90 minutes.

To the water-in-oil emulsion is added 0.015 g of AIBN (2,2′-azobis(isobutyronitrile), available from E.I. duPont Nemours & Co. Inc.; Wilmington, Del.) and 0.002 g of AIVN (2,2′-azobis(2,4-dimethylvaleronitrile), available from E.I. dupont Nemours & Co. Inc.; Wilmington, Del.). The polymerization is carried out under a N₂ atmosphere for 4 hr. at 45° C., then 60° C. for one hour. An RSV of 4.0 dl/g (1M NaNO₃, 450 ppm, 30° C.) is measured for the resulting polymer.

### EXAMPLE 10

Fluorescent acrylamide dry powder polymer with Tag (24), is prepared in the following manner:

In a 600 mL insulated reaction flask, 125.77 g of deionized water, 254 g of acrylamide solution (48.7%), 0.190 g of sodium hydroxide solution (50%), 0.43 g of acetic acid, and 0.12 g of Tag (24) (0.2 mmol) are combined. To this solution is added 5.0 g of a 4% solution of V-501 (Wako Chemicals USA, Inc., Richmond, Va.), 1.54 g of a 10% solution of Versenex 80 (Dow Chemical Co., Midland, Mich.), 2.8 g of a 0.10% solution of sodium hypophosphite, 4.8 g of a 0.125% solution of ammonium persulfate, and 2.0 g of a 0.2% solution of ferrous ammonium sulfate. After this, the solution is purged with nitrogen, and within a few minutes the temperature of the solution is allowed to increase adiabatically. After the temperature attains its maximum value, the reactor contents are allowed to cool to ambient temperature. The resulting polymer is shredded, dried, and ground to a fine powder.

### EXAMPLE 11

A partially neutralized acrylic acid solution polymer with Tag (28) is prepared in the following manner:

To a 1.5 L reaction flask equipped with an agitator, a thermocouple, a nitrogen purge tube and a reflux condenser is added 64 g of deionized water, 450 g of acrylic acid, 22.5 g of sodium hydroxide (50% solution) and 0.24 g of Tag (28) (0.6 mmol). This mixture is heated to 70° C. and purged with nitrogen with vigorous mixing. Eight grams of ammonium persulfate is dissolved in 23 g of deionized water, and, separately, 79 g of sodium bisulfite is dissolved in 197 g of deionized water. The ammonium persulfate solution is added to the reaction mixture at the rate of 12 mL/hour, and the sodium bisulfite solution is added to the reaction mixture at the rate of 102 mL/hour. After 3.5 hours, 155 g of deionized water is added and the reaction mixture is cooled to room temperature to provide the solution polymer.

### EXAMPLE 12

The use of tagged polymers in monitoring polymer location and in dosage control is demonstrated utilizing polymers B (Table II) and C (Table III) to dewater sludge from a midwestern municipal wastewater treatment facility.

A free-drainage test is performed to evaluate the dewatering performance of the tagged polymers. A 3000 ppm solution of the tagged polymer to be tested is prepared. To perform the drainage test, 200 ml of the municipal sludge is placed in a 500 ml graduated cylinder. Polymer is added to the cylinder at the desired concentration, and mixed by inverting the cylinder twice. Flocculated sludge is then poured through a belt filter press cloth and the amount of water drained in 10 seconds is utilized as a measure of the polymer performance. The effluent is collected, and samples are centrifuged for 20 minutes at 26,000 rpm to separate any residual solid material which passes through the filter.

The fluorescence of the concentrate is analyzed directly using a Hitachi F-4500 fluorescence spectrophotometer.

Table II
Polymer B Detection after Municipal Sludge Dewatering

| | | Polymer Concentration |
|---|---|---|
| Polymer Dose (ppm)¹ | Drainage (ml)² | In Filtrate (ppm)³ |
| 40.0 | 44.3 | 0 |
| 66.6 | 69.6 | 2.4 |
| 93.3 | 84.0 | 11.8 |
| 120.0 | 86.3 | 25.2 |

¹Polymer concentration in the sludge matrix (2.07% solids).
²The amount of supernatant which flowed through a belt filter press cloth in 10 seconds, after polymer treatment.
³EX/EM = 550/590 nm, background fluorescence from the sludge matrix subtracted. Polymer concentration determined from a calibration curve.

TABLE III
Polymer C Detection after Municipal Sludge Dewatering

| | | Polymer Concentration |
|---|---|---|
| Polymer Dose (ppm)¹ | Drainage (ml)² | In Filtrate (ppm)³ |
| 13.1 | 47.6 | 2.0 |
| 26.2 | 90.7 | 4.4 |
| 39.3 | 121.6 | 9.1 |
| 52.3 | 142.7 | 14.0 |
| 65.4 | 145.0 | 20.9 |
| 78.5 | 144.2 | 26.1 |

¹Polymer concentration in the sludge matrix.
²The amount of supernatant which flowed through a belt filter press cloth in 10 seconds, after polymer treatment.
³EX/EM = 428/522 mm. Polymer concentration determined from a calibration curve. The background fluorescence from a sludge matrix subtracted.

We claim:

1. A fluorescent water-soluble polymer comprising from about 0.0001 to about 10.0 mole percent of one or more fluorescent monomer units of formula 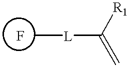
wherein 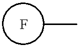
is a fluorescent moiety selected from 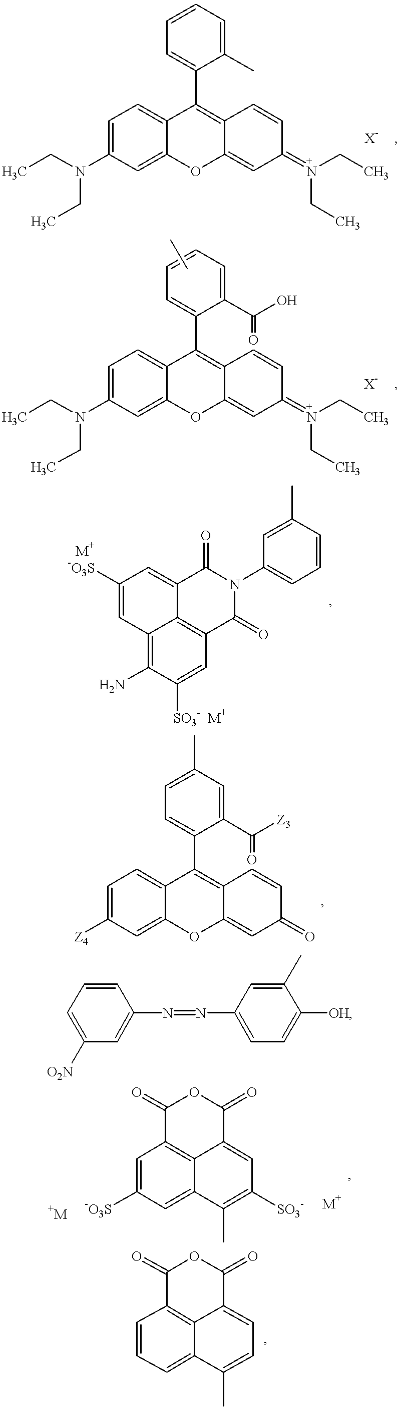
L is selected from —SO₂—, —Y₁C(O)—, —R₂—Y₁—C(O)— and —Y₁—C(Z₁)—Y₂—(CH₂)ₙ—Y₃—C(Z₂)—;
Y₁ is absent, O, or NR₃;
Y₂ and Y₃ are independently O or NR₃;
Z₁ and Z₂ are independently O or S;
Z₃ and Z₄ are independently OH or O⁻M⁺;
n is an integer of from 2 to 6;
R₁ and R₃ are independently hydrogen or C₁-C₄ alkyl;
R₂ is C₁-C₄ alkylene;
X is Br, Cl or I;
M is Na, Li or K,
and from 90 to 99.9999 mole percent of one or more second monomer units selected from the group consisting of cationic, anionic, nonionic and zwitterionic monomers, provided that when the fluorescent water-soluble polymer consists of randomly distributed fluorescent monomer units of formula 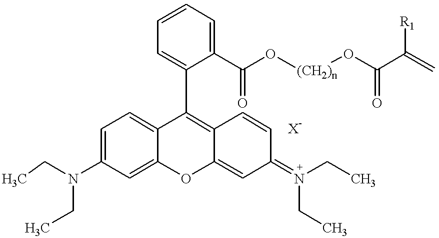
and randomly distributed second monomer units which are diallyldimethyl ammonium chloride, then R₁ is C₁-C₄ alkyl.

2. The fluorescent water-soluble polymer of claim 1 comprising from about 0.02 to about 0.5 mole percent fluorescent monomer units and from about 99.98 to about 99.5 mole percent second monomer units.

3. The fluorescent water-soluble polymer of claim 2 wherein the fluorescent monomers are selected from

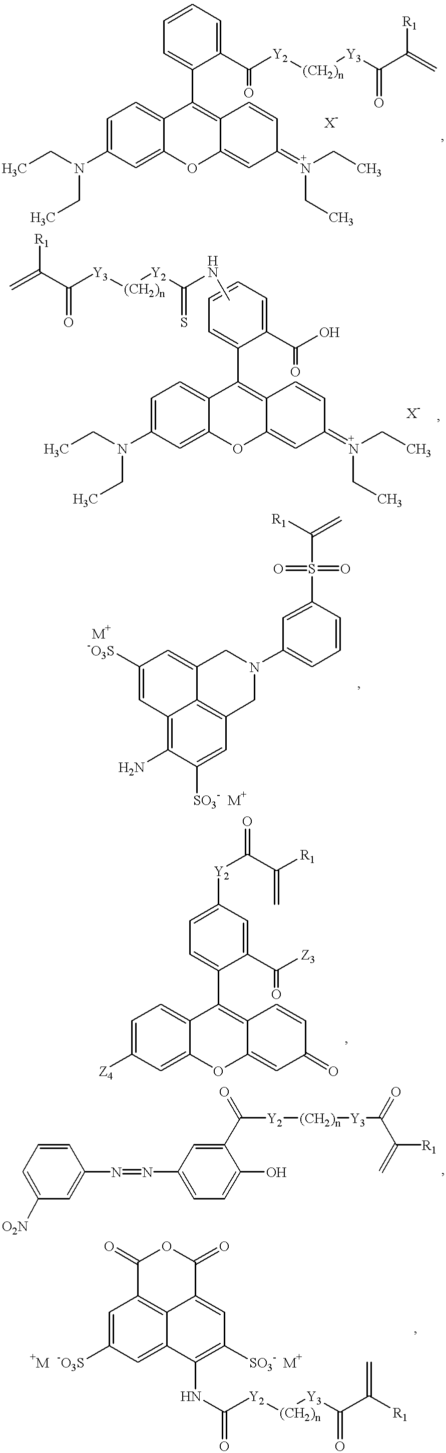

4. The water-soluble fluorescent polymer of claim 3 wherein the second monomers are selected from acrylamide, dimethylaminoethylacrylate methyl chloride quaternary salt, dimethylaminoethylmethacrylate methyl chloride quaternary salt, sodium acrylate, ammonium acrylate, acrylamidopropyltrimethylammonium chloride and methacrylamidopropyltrimethylammonium chloride.

5. The water-soluble fluorescent polymer of claim 3 wherein the second monomers are selected from acrylamide, dimethylaminoethylacrylate methyl chloride quaternary salt, sodium acrylate and ammonium acrylate.

6. The fluorescent water-soluble polymer of claim 5 wherein the fluorescent monomers are selected from:

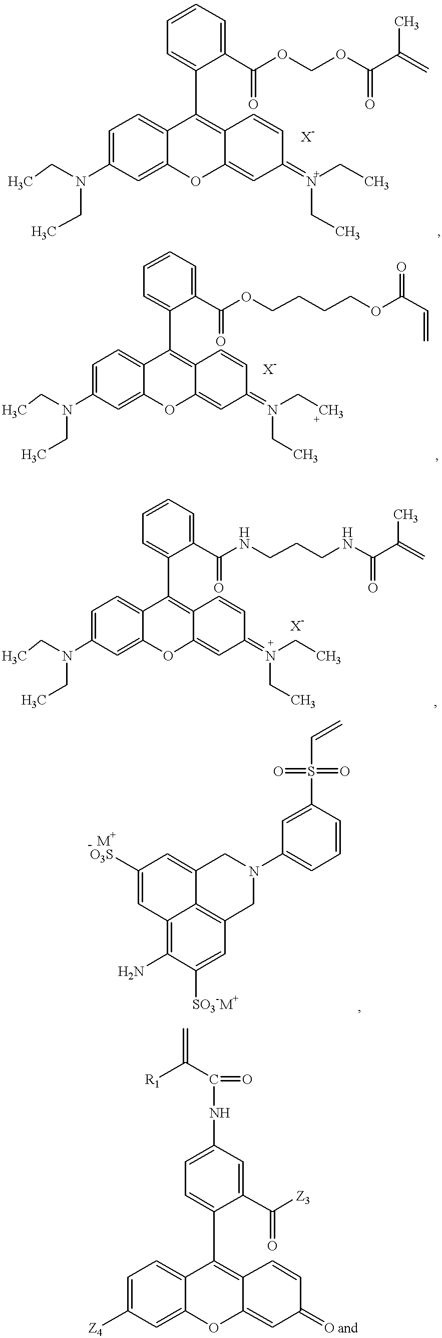

7. The fluorescent water-soluble polymer of claim 1 further comprising a cross-linker.

8. A fluorescent monomer of formula 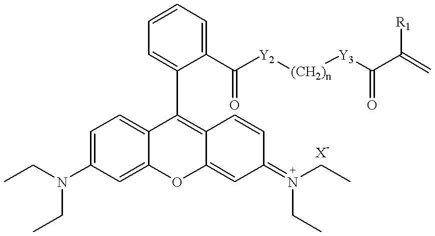
wherein
Y₂ and Y₃ are independently O or NR₃;
R₁ is C₁-C₄ alkyl;
n is an integer of from 2 to 6; and
X is Br, Cl or I.

9. The fluorescent monomer of claim 8 wherein R₁ is methyl.

10. The fluorescent monomer of claim 8 wherein R₁ is methyl, Y₂ and Y₃ are O and n is 2.

11. The fluorescent monomer of claim 8 wherein R₁ is methyl, Y₂ and Y₃ are NH and n is 3.

12. A method of monitoring a fluorescent water-soluble polymer in treated water comprising adding to the water-soluble fluorescent water-soluble polymer of claim 1 and monitoring the water-soluble fluorescent polymer by fluorescence detection.

13. A method of controlling the dosage of a water-soluble polymeric treating agent added to water comprising:
a) adding a predetermined amount of the water-soluble fluorescent polymer of claim 1 to the water,
b) monitoring the change in fluorescence of the water-soluble fluorescent polymer and
c) adjusting the concentration of the polymeric treating agent accordingly.

14. A composition comprising a water-soluble fluorescent polymer according to claim 1 and a polymeric treating agent.
